(19) United States
(12) Patent Application Publication
(10) Pub. No.: US 2012/0073396 A1
(43) Pub. Date: Mar. 29, 2012

(54) MOTION GUIDE DEVICE AND SCREW DEVICE

(75) Inventors: Takahiro Kawaguchi, Tokyo (JP); Ryuji Furusawa, Tokyo (JP); Yuki Nakamura, Tokyo (JP); Yosuke Irie, Tokyo (JP); Satoshi Kashiwagura, Tokyo (JP); Masanori Yoshino, Tokyo (JP); Masaaki Hihara, Tokyo (JP); Shinya Mori, Tokyo (JP); Katsuya Iida, Tokyo (JP); Atsushi Kawamura, Tokyo (JP)

(73) Assignee: THK CO., LTD., Tokyo (JP)

(21) Appl. No.: 13/375,149

(22) PCT Filed: May 21, 2011
(86) PCT No.: PCT/JP2010/058641

§ 371 Date: Nov. 29, 2011

(30) Foreign Application Priority Data
May 29, 2009 (JP) 2009-130825
Apr. 23, 2010 (JP) 2010-099877

(51) Int. Cl. F16H 25/12; F16C 33/10; F16C 29/06

(52) U.S. Cl. 74/424.82; 384/15; 384/13

(57) ABSTRACT

Provided are a motion guide device and a screw device each having a cover for protecting the device against moisture, such as coolant, and powder dust. The motion guide device has a raceway member 11, a moving member main body 21 mounted on the raceway member 11 through a plurality of rolling elements and cap members 22 attached to respective end surfaces of the moving member main body 21 in a relative moving direction. A seal cover 50 is provided having a cover main body 51 that covers each of the cap members 22 and a seal section 55 that is provided between the cover main body 51 and a cap member-side end surface of the moving member main body 21 to stop a gap between the cap member-side end surface of the moving member main body 21 and the cover main body 51. This structure makes it possible to reliably prevent any foreign material, such as powder dust or swarf, and moisture, such as coolant, from getting into the inside of the moving member 20.

### TECHNICAL FIELD

The present invention relates to a motion guide device having a plurality of rolling elements arranged rollable between a raceway member and a moving member and to a screw device having a plurality of rolling elements arranged rollable between a screw shaft and a nut. Particularly, the present invention relates to a motion guide device and a screw device suitable for use in an environment where moisture, such as coolant, and powder dust are scattered.

### BACKGROUND ART

The motion guide device is a mechanical element for guiding linear or curve movement of an object such as a table. Known as such a motion guide device is a linear guide that has a raceway rail and a moving block mounted movable along the raceway rail. In order to smooth movement of the moving block relative to the raceway rail, a plurality of rolling elements (balls or rollers) is arranged rollable between the raceway rail and the moving block. The moving block has a moving block main body and a pair of endplates provided on the respective ends of the moving block main body in the moving direction. The raceway rail has a rolling-element rolling groove formed therein extending in the longitudinal direction. The moving block main body has formed therein a loaded rolling-element rolling groove facing the rolling-element rolling groove of the raceway rail and a rolling-element return path extending in parallel with the loaded rolling-element rolling groove. Each endplate has formed therein an arc-shaped direction change path that connects one end of the loaded rolling-element rolling groove to an end of the rolling-element return path. The rolling-element rolling groove of the raceway rail and the loaded rolling-element rolling groove of the moving block main body form a loaded rolling-element rolling path. The loaded rolling-element rolling path, an unloaded rolling-element return path and a pair of direction change paths form a circular rolling-element circulation path. The plural rolling elements are arranged and accommodated in this rolling-element circulation path.

The linear guide is used in various industrial machines or working machines, and its use environment varies widely. For example, the linear guide is sometimes used in an environment where there are plenty of swarf and powder dust. In such a case, entry of any foreign material, such as powder dust, into the linear guide causes wearing and reduced service life. Therefore, it is necessary to prevent entry of the foreign material. As the structure to prevent entry of any foreign material, PL1 discloses a dust-proof cover which is fit over the linear guide so as to cover a gap between moving blocks mounted on the raceway rail at a predetermined mounting span and to fully cover the components such as the endplates at respective ends of the moving block. The dust-proof cover is fit over the components such as endplates, and then, it is fixed to the components by its elastic force. With such a dust-proof cover, it is possible to prevent accumulation of dust particles between the moving blocks, even when the linear guide is used in the environment with plenty of foreign materials. Further, as each endplate is generally made of resin, and it is covered with the dust-proof cover, thereby preventing deformation of the endplate due to a high-temperature foreign material.

### CITATION LIST

### Patent Literature

PL1: Japanese Patent No. 4109341

### SUMMARY OF INVENTION

### Technical Problem

However, the linear guide used in a working machine is often exposed to moisture, such as coolant, in addition to powder dust and swarf. The coolant water may easily enter a small gap in the linear guide. If the powder dust or swarf is mixed with the coolant, it may enter the inside of the linear guide with the coolant, which causes damages to the linear guide. Accordingly, it is necessary to prevent the linear guide also from the coolant water.

However, it is difficult to completely flatten each end surface of the moving block main body and each surface of each endplate in contact with the moving block main body or other components in contact with the endplates, and there is a small gap created therebetween so that moisture, such as coolant, may enter the inside thereof. When the moisture, such as coolant, enters the inside of the moving block, the solid state property of a lubricant inside the moving block may be transformed by moisture and then, it becomes difficult to achieve an excellent lubricating state.

The dust-proof cover disclosed in the above-mentioned PL1 is configured to cover a component attached to an end of the moving block main body, such as an endplate, and a space between two moving blocks. However, it is difficult to prevent entry of moisture into a slight gap between components such as the endplate and the end surface of the mobbing block main body.

Then, the present invention aims to provide a motion guide device and a screw device each capable of preventing entry of any foreign material, such as powder dust, and moisture, such as coolant, into the device with reliability.

### Solution to Problem

In order to solve the above-mentioned problems, a first aspect of the present invention is a motion guide device comprising: a raceway member having a rolling-element rolling part that extends in a longitudinal direction; a moving member having a moving member main body and cap members, the moving member main body having a loaded rolling-element rolling part facing the rolling-element rolling part of the raceway member and a rolling-element return path extending approximately in parallel to the loaded rolling-element rolling part, and the cap members being provided at respective ends of the moving member main body in a relative moving direction and having direction change paths formed therein that connect the loaded rolling-element rolling part of the moving member main body and the rolling-element return path; a plurality of rolling elements being arranged in a rolling-element circulation path that includes a loaded rolling-element rolling path between the rolling-element rolling part of the raceway member and the loaded rolling-element rolling part of the moving member main body, the rolling-element return path and the direction change paths; and a seal cover having a cover main body that covers each of the cap members and a seal section that is provided between the cover main body and a cap member-side end surface of the moving member main body to stop a gap between the cap member-side end surface of the moving member main body and the cover main body.

Further, a second aspect of the present invention is a seal cover mounted on a motion guide device having a raceway member having a rolling-element rolling part that extends in a longitudinal direction, a moving member having a moving member main body and cap members, the moving member main body having a loaded rolling-element rolling part facing the rolling-element rolling part of the raceway member and a rolling-element return path extending approximately in parallel to the loaded rolling-element rolling part, and the cap members being provided at respective ends of the moving member main body in a relative moving direction and having direction change paths formed therein that connect the loaded rolling-element rolling part of the moving member main body and the rolling-element return path, and a plurality of rolling elements being arranged in a rolling-element circulation path that includes a loaded rolling-element rolling path between the rolling-element rolling part of the raceway member and the loaded rolling-element rolling part of the moving member main body, the rolling-element return path and the direction change paths, the seal cover comprising: a cover main body that covers each of the cap members; and a seal section that is provided between the cover main body and a cap member-side end surface of the moving member main body to stop a gap between the cap member-side end surface of the moving member main body and the cover main body.

Furthermore, a third aspect of the present invention is a motion guide device comprising: a raceway member having a rolling-element rolling part that extends in a longitudinal direction; a moving member having a moving member main body and cap members, the moving member main body having a loaded rolling-element rolling part facing the rolling-element rolling part of the raceway member and a rolling-element return path extending approximately in parallel to the loaded rolling-element rolling part, and the cap members being provided at respective ends of the moving member main body in a relative moving direction and having direction change paths formed therein that connect the loaded rolling-element rolling part of the moving member main body and the rolling-element return path; a plurality of rolling elements being arranged in a rolling-element circulation path that includes a loaded rolling-element rolling path between the rolling-element rolling part of the raceway member and the loaded rolling-element rolling part of the moving member main body, the rolling-element return path and the direction change paths; and a cover configured to cover each of the cap members, the cover having an end wall for covering an outer end surface of the cap member in the relative moving direction or an outer end surface of at least one auxiliary device including a lubricating device and a device for preventing entry of any foreign material, the end wall of the cover having a through hole formed therein for inserting a fastening member, the fastening member being inserted into the through hole of the end wall and tightened to the moving member so that the cover is pushed to a cap member-side end surface of the moving member main body to come into intimate contact with the cap member-side end surface of the moving member main body.

Further, a fourth aspect of the present invention is a screw device comprising: a screw shaft having a spiral rolling-element rolling part formed on an outer peripheral surface; a nut main body having a spiral loaded rolling-element rolling part that is formed on an inner peripheral surface to face the rolling-element rolling part of the screw shaft and a rolling-element return path that connects one end of the loaded rolling-element rolling part to an opposite end; cap members that are provided at respective ends of the nut main body and have direction change paths formed therein connecting the rolling-element return path and the loaded rolling-element rolling part of the nut main body; a plurality of rolling elements that are arranged in a loaded rolling-element rolling path between the rolling-element rolling part of the screw shaft and the loaded rolling-element rolling part of the nut main body, the rolling-element return path and the direction change paths; and a seal cover having a cover main body that covers each of the cap members and a seal section that is provided between the cover main body and a cap member-side end surface of the nut main body to stop a gap between the cap member-side end surface of the nut main body and the cover main body.

### Advantageous Effects of Invention

According to the first and second aspects of the present invention, the cap member is covered with the cover main body and a gap between the cover main body and the moving member main body is stopped with the seal section so that a gap between the cap member and the moving member main body can be stopped. Accordingly, it is possible to reliably prevent entry of moisture, such as coolant, or foreign material, such as swarf or dust particles, into the moving member.

According to the third aspect of the present invention, the cover to cover the cap member is brought into close contact with the moving block main body so that the gap between the cap member and the moving member main body can be stopped. Accordingly, it is possible to reliably prevent entry of moisture, such as coolant, or foreign material, such as swarf or dust particles, into the moving member.

According to the fourth aspect of the present invention, the cap member is covered with the cover main body and a gap between the cover main body and the nut main body is stopped with a seal section so that the gap between the cap member and the nut main body can be stopped. Accordingly, it is possible to reliably prevent entry of moisture, such as coolant, or foreign material, such as swarf or dust particles, into the screw device.

### BRIEF DESCRIPTION OF DRAWINGS

FIG. 1 is a perspective view illustrating a linear guide as a motion guide device according to one embodiment of the present invention;

FIG. 2 is a perspective view illustrating the linear guide from which a seal cover is removed (including a partial cross sectional view thereof);

FIG. 3 is a cross sectional view taken along the line A-A of FIG. 2;

FIG. 4 is an exploded perspective view of a moving block;

FIGS. 5(a) and 5(b) are views of a cover main body (FIG. 5(a) is a perspective view and FIG. 5(b) is a side view);

FIGS. 6(a) and 6(b) are views of a seal section (FIG. 6(a) is a front view and FIG. 6(b) is a side view);

FIG. 7 is an exploded perspective view illustrating another example of a linear guide (including a partial cross sectional view);

FIG. 8 is a cross sectional view taken along the line B-B of FIG. 7;

FIG. 9 is a perspective view illustrating another example of the linear guide according to the embodiment of the present invention;

FIG. 10 is a cross sectional view taken along the longitudinal direction of the linear guide;

FIGS. 11(a) and 11(b) are views of a cover main body (FIG. 11(a) is a front view and FIG. 11(b) is a side view);

FIGS. 12(a) and 12(b) are views of a seal section (FIG. 12(a) is a cross sectional view and FIG. 12(b) is a lateral view);

FIGS. 13(a) and 13(b) are process charts of the method of mounting the cover main body and the seal section (FIG. 13(a) illustrates the seal section mounted and FIG. 13(b) illustrates the state immediately before the cover main body is mounted);

FIGS. 14(a) and 14(b) are perspective views each illustrating a modified example of the cover (FIG. 14(a) illustrates a first modified example and FIG. 14(b) illustrates a second modified example);

FIGS. 15(a) and 15(b) are views each illustrating a modified example of the seal section (FIG. 15(a) illustrates a modified example and FIG. 15(b) illustrates another modified example);

FIGS. 16(a) to 16(c) are views each illustrating a modified example of the cover main body (FIG. 16(a) illustrates a modified example, FIG. 16(b) illustrates another modified example and FIG. 16(c) illustrates yet another modified example);

FIGS. 17(a) and 17(b) are views each illustrating a modified example of the endplate (FIG. 17(a) illustrates a modified example and FIG. 17(b) illustrates another modified example);

FIGS. 18(a) to 18(c) are views each illustrating a modified example of the seal section on which measures against coolant are taken (FIG. 18(a) illustrates a modified example, FIG. 18(b) illustrates another modified example and FIG. 18(c) illustrates yet another modified example); and

FIG. 19 is a perspective view illustrating a screw device according to a second embodiment of the present invention.

### DESCRIPTION OF EMBODIMENTS

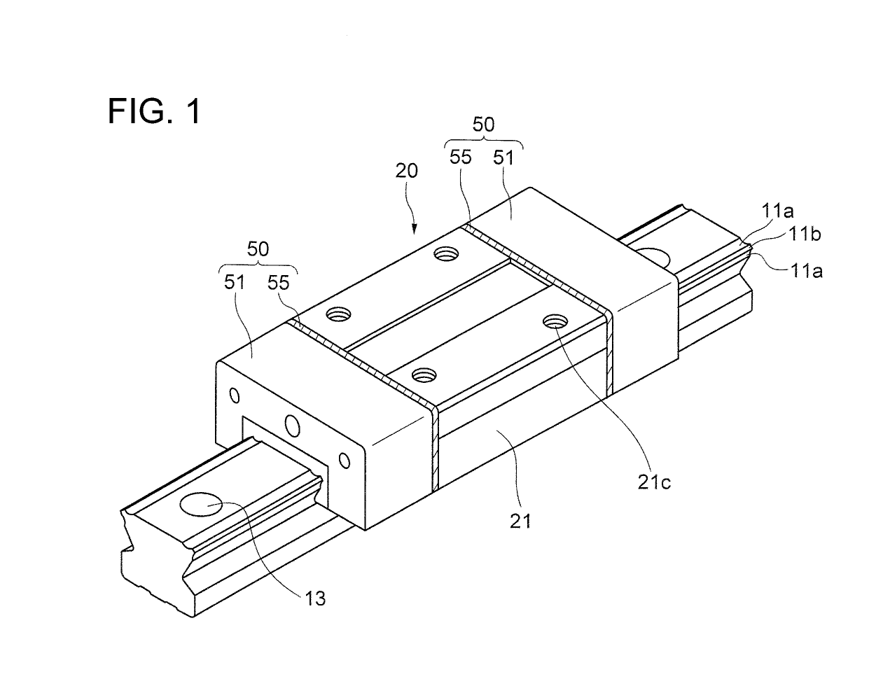

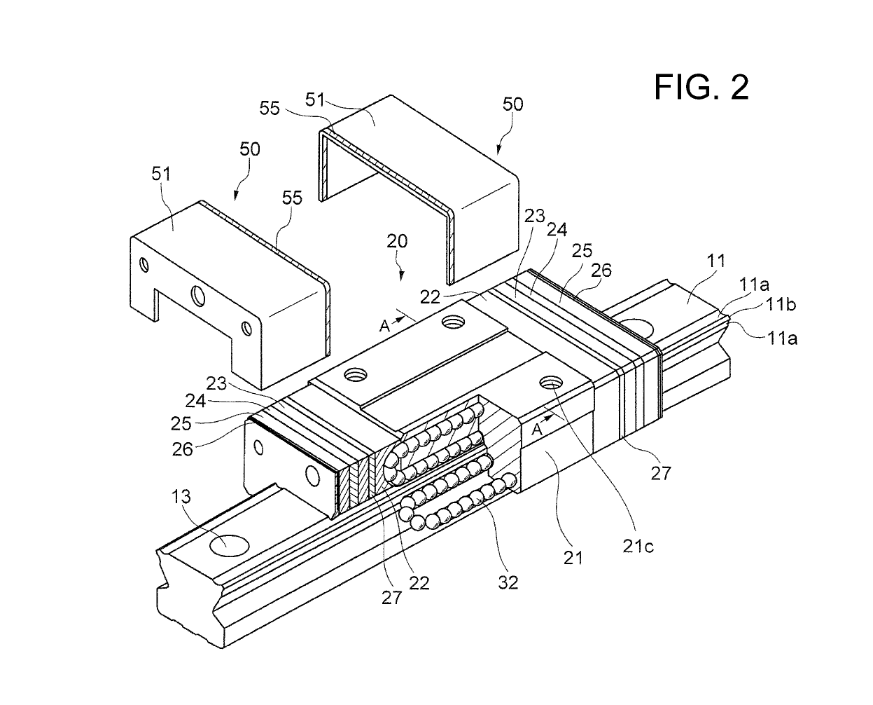

With reference to the attached drawings, description will be made about a linear guide as a motion guide device according one embodiment of the present invention. FIGS. 1 and 2 are perspective views of the linear guide. FIG. 1 illustrates the linear guide provided with a seal cover (seal-equipped cover) 50 as a cover, which is a feature of the present invention. FIG. 2 illustrates the linear guide from which the seal cover 50 is removed. The linear guide according to this embodiment has a raceway rail 11 as a raceway member extending linearly and a moving block 20 as a moving member mounted on the raceway rail 11 to be movable along the raceway rail 11. Between the raceway rail 11 and the moving block 20, a plurality of balls 32 is provided rollable as rolling element.

The raceway rail 11 is a long member having an approximately box-shaped cross section. At upper end of each of right and left side surfaces of the raceway rail 11, a projection 11b is provided extending in the longitudinal direction. At the upper and lower sides of the projection 11b, ball rolling grooves 11a are formed as rolling-element rolling parts. The raceway rail 11 has totally four ball rolling grooves 11a formed therein. The cross sectional shape of each ball rolling groove 11a is a circular arc groove shape formed of a single arc or a Gothic arch groove shape formed of combined two arcs. In the raceway rail 11, plural bolt holes 13 are formed a predetermined distance separated from each other along the longitudinal direction. Fixing bolts are inserted these bolt holes 13, respectively, thereby to secure the raceway rail 11 to a fixing part of a column, bed or the like.

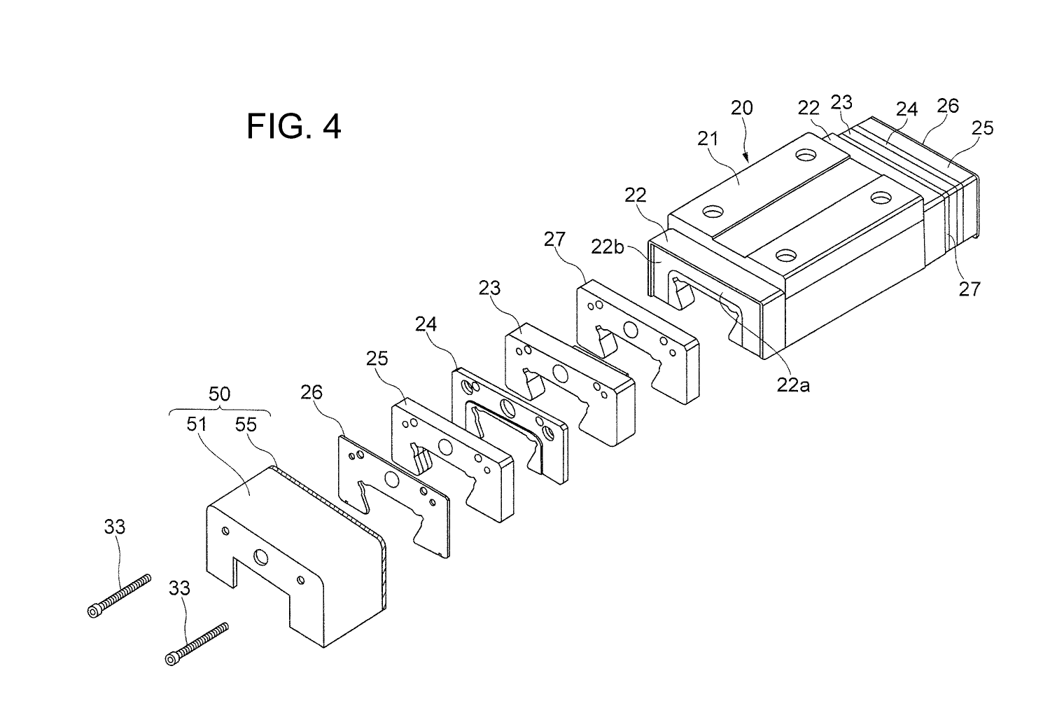

FIG. 4 is an exploded perspective view of the moving block as a moving member. The moving block 20 has a moving block main body 21 as a moving member main body, endplates 22 as cap members provided at the respective ends of the moving block main body 21 in the moving direction, intermediate plates 27 provided outside the respective endplates 22 in the moving direction, lubricating devices 23 provided outside the respective intermediate plates 27 in the moving direction, end seals 24 provided outside the respective lubricating devices 23 in the moving direction, laminated-type contact scrapers 25 provided outside the respective end seals 24 in the moving direction, and metal scrapers 26 provided outside the respective laminated-type contact scrapers 25 in the moving direction. Here, the intermediate plates 27, the lubricating devices 23, the end seals 24, the laminated-type contact scrapers 25 and the metal scrapers 26 are auxiliary devices, which are mounted when necessary.

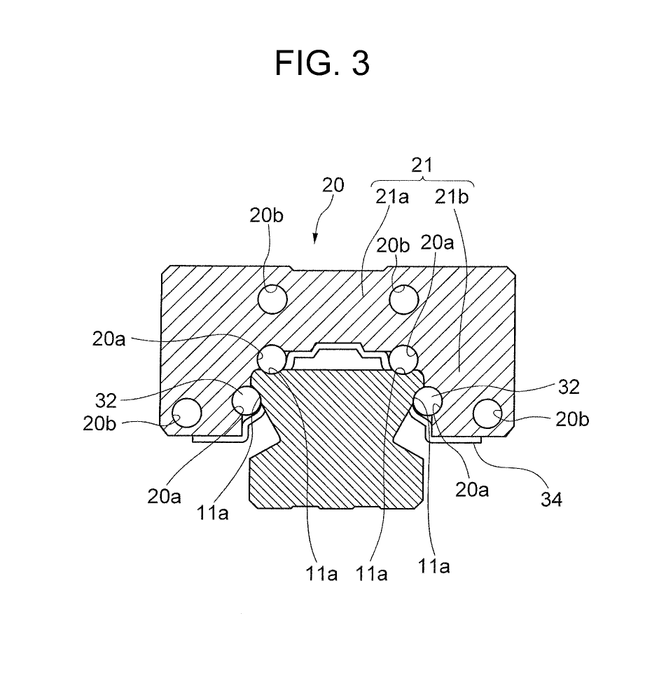

The moving block main body 21 as the moving member main body is formed like a saddle having a horizontal part 21a facing an upper surface of the raceway rail 11 and a pair of arm parts 21b facing respective side surfaces of the raceway rail 11, as illustrated in FIG. 3, when the raceway rail 11 is arranged on a horizontal plane. In the horizontal part 21a of the moving block main body 21, screw holes 21c (see FIG. 1) are formed for securing the moving block to a table to guide or the like.

Inside the moving block main body 21, a loaded ball rolling groove 20a as a loaded rolling-element rolling part is formed at each of the sides between the horizontal part 21a and the side parts 21b. The loaded ball rolling grooves 20a face the respective ball rolling grooves 11a of the raceway rail 11 and the moving block main body 21 has totally four loaded ball rolling grooves 20a (see FIG. 3). The cross sectional shape of each loaded ball rolling groove 20a is a circular arc groove shape formed of a single arc or a Gothic arch groove shape formed of combined two arcs, like the ball rolling groove 11a. Between the ball rolling grooves 11a of the raceway rail 11 and the corresponding loaded ball rolling grooves 20a of the moving block main body 21, loaded ball rolling paths are formed as loaded rolling-element rolling paths in which the balls 32 roll under load. In the moving block main body 21, a ball return path 20b is formed as a rolling-element return path in parallel to each loaded ball rolling path and separated from the corresponding loaded ball rolling groove 20a by a predetermined distance. The balls 32 return in the ball return paths 20b out of the load.

Each endplate 22 as a cap member takes an approximately identical shape to the front surface shape of the moving block main body 21 and the endplates 22 are attached to the respective ends of the moving block main body 21 astride the raceway rail 11. That is, each endplate 22 is approximately saddle-shaped having a horizontal part 22a facing the upper surface of the raceway rail 11 and a pair of arm parts 22b facing the left and right side surfaces of the raceway rail 11, respectively, as illustrated in FIG. 4, when the raceway rail 11 is arranged on a horizontal plane. The endplate 22 has formed therein an outer peripheral part of a U-shaped direction change path that connects a loaded ball rolling path formed of the ball rolling groove 11a of the raceway rail 11 and the loaded ball rolling groove 20a (see FIG. 3) of the moving block main body 21 to the ball return path 20b (see FIG. 3). The inner peripheral part of the direction change path is formed integral with the moving block main body 21. Such direction change paths, the loaded ball rolling path and the ball return path form a circular ball circulation path. In the ball circulation path, plural balls 32 are arranged. The balls 32 are held by a holding plate 34 in the loaded ball rolling path. In order to prevent contact between balls, a spacer (not shown) may be provided between each adjacent two of the balls 32 or the balls 32 may be liked to each other by a band retainer.

The intermediate plate 27 is a device for filling a gap that is created in the seal cover 50 after the auxiliary devices such as the lubricating device 23 and the endplate 22 are accommodated therein. When the endplate 22 is only accommodated in the seal cover 50, the intermediate plate 27 acts to fill a gap that is created in the seal cover 50 after the endplate 22 is only accommodated in the seal cover 50. As the intermediate plate 27 is provided, the moving block main body 21, the endplate 22 and each auxiliary device can be brought into intimate contact with each other in mounting the seal cover 50 described later. Besides, the endplate 22 sometimes has a recess or projection on the outer end surface thereof, and the intermediate plate 27 absorbs such recess or projection so that the auxiliary devices such as lubricating device 23 can be easily attached thereto. The intermediate plate 27 has an approximately identical shape to the front surface of the moving block main body 21 and is mounted as an auxiliary device to each outer end surface of the endplate 22 in the moving direction astride the raceway rail 11.

The lubricating device 23 is a device for supplying a lubricant, such as lubricating oil or grease, or the like to the ball rolling grooves 11a of the raceway rail 11. The lubricating device 23 takes a shape approximately identical to the front surface shape of the moving block main body 21 and provided astride the raceway rail 11 and outside each intermediate plate 27 in the moving direction as an auxiliary device.

The end seal 24 is a device for preventing any foreign material attached to the surface of the raceway rail 11 from entering the inside of the moving block 20. The end seal 24 takes a shape approximately identical to the front surface shape of the moving block main body 21 and is provided astride the raceway rail 11 and outside each lubricating device 23 in the moving direction as an auxiliary device. Here, the inner peripheral surface of the end seal 24 has a lower part that protrudes in conformity with the shape of the raceway rail 11 and in contact with the surface of the raceway rail 11.

The laminated-type contact scraper 25 is a device to prevent any fine foreign material from getting into the moving block 20. The laminated-type contact scraper 25 is formed to have an approximately identical shape to the front surface of the moving block main body 21, and is provided astride the raceway rail 11 and outside each end seal 24 in the moving direction as an auxiliary device. Besides, the laminated-type contact scraper 25 is formed of felt plates that are laminated in the moving direction in a casing. The inner peripheral surface of the laminated-type contact scraper 25 has a lower part that protrudes a little conforming to the shape of the raceway rail 11 and is in contact with the raceway rail 11.

The metal scraper 26 is a device for removing any foreign material like spatter that may be stuck to the raceway rail 11. The metal scraper 26 takes an approximately identical shape to the front shape of the moving block main body 21 and is provided astride the raceway rail 11 and outside each laminated-type contact scraper 25 in the moving direction as an auxiliary device. The inner peripheral surface of the metal scraper 26 is out of contact with the surface of the raceway rail 11.

The endplate 22, the intermediate plate 27, the lubricating device 23, the end seal 24, the laminated-type contact scraper 25 and the metal scraper 26 are laminated and covered with the seal cover 50, and then mounted onto each end of the moving block main body 21 with use of fastening members, such as mounting bolts 33.

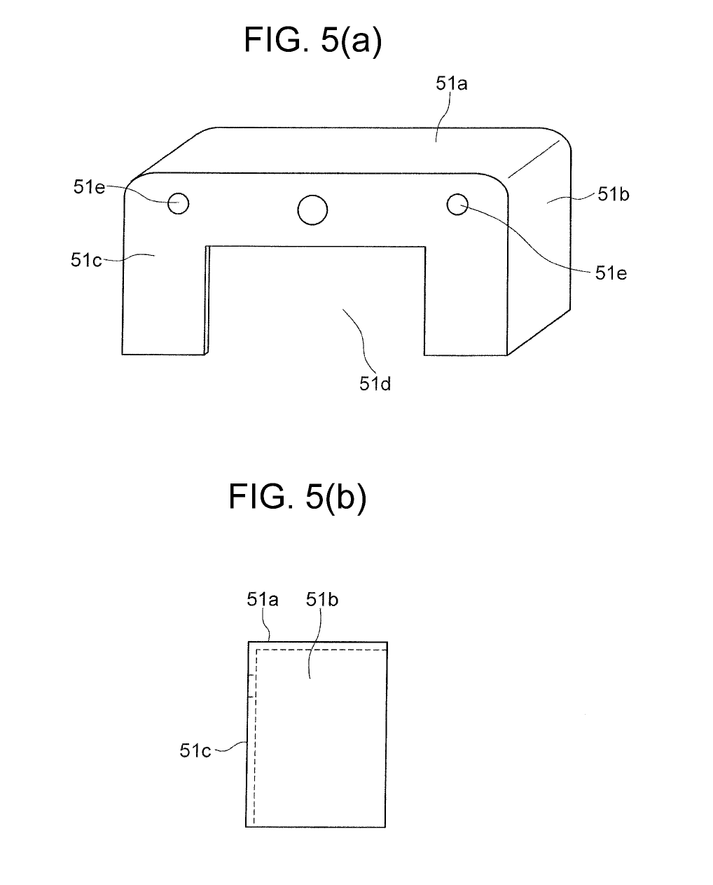

Next description is made about the seal cover 50 which is a feature of the present invention. As illustrated in FIG. 2, the seal cover 50 has a cover main body 51 and a seal section 55. First description is made about the cover main body 51, with reference to the perspective view of FIG. 5 (a) and the side view of FIG. 5(b).

The cover main body 51 has an upper wall 51a covering the upper surfaces of the horizontal parts of the endplate 22 and auxiliary devices, a pair of side walls 51b covering left and right side surfaces of the arm parts of the endplate 22 and auxiliary devices and an end wall 51c covering an outer end surface of an outermost auxiliary device in the moving direction. The upper wall 51a of the cover main body 51 is formed to have such a size as to cover the upper surfaces of the endplate 22 and auxiliary devices including the metal scraper 26 entirely. Each side wall 51b of the cover main body 51 extends from an end of the upper wall 51a in the horizontal direction approximately vertically downward and is formed to have such a size as to cover the side surfaces of the endplate 22 and auxiliary devices including the metal scraper 26 entirely. The upper wall 51a and the paired side walls 51b are formed to have a U-shaped cross section orthogonal to the moving direction of the moving block 20. Besides, the end wall 51c is mounted onto an end of the upper wall 51a in the moving direction. The opposite end of the upper wall 51a is open so as to insert the endplate 22 and other auxiliary devices. The end wall 51c has a cross section orthogonal to the moving direction, which is approximately identical to the shape of the moving block main body 21. The reference numeral 51d is an open part in the end wall 51c and is formed in such a size as to prevent interference between the cover main body 51 and the raceway rail 11 in relative movement of the moving block. The end wall 51c has a pair of bolt holes 51e formed symmetrically therein. As described above, the endplate 22 and various auxiliary devices 23 to 27 are laminated and covered with the seal cover 50. Then, the mounting bolts 22 (see FIG. 4) as fastening members are inserted into the bolt holes 51e, respectively, in the moving direction of the moving block 20 so that the endplate 22 and various auxiliary devices 23 to 27 and the seal cover 50 are tightly fastened to the moving block main body 21 with no gap created therein. In the moving block main body 21, screw holes are formed for insertion of the mounting bolts 33. The upper wall 51a, the side walls 51b and the end wall 51c of the cover main body 51 are formed integrally by welding or bending. The cover main body 51 of this embodiment is made of metal such as stainless steel. If no auxiliary device is provided, the cover main body 51 has an upper wall 51a covering the upper surface of the horizontal part 22a of the endplate 22, a pair of side walls 51b covering side surfaces of the left and right arm parts 22b of the endplate 22 and an end wall 51c covering the outer end surface of the endplate 22 in the moving direction.

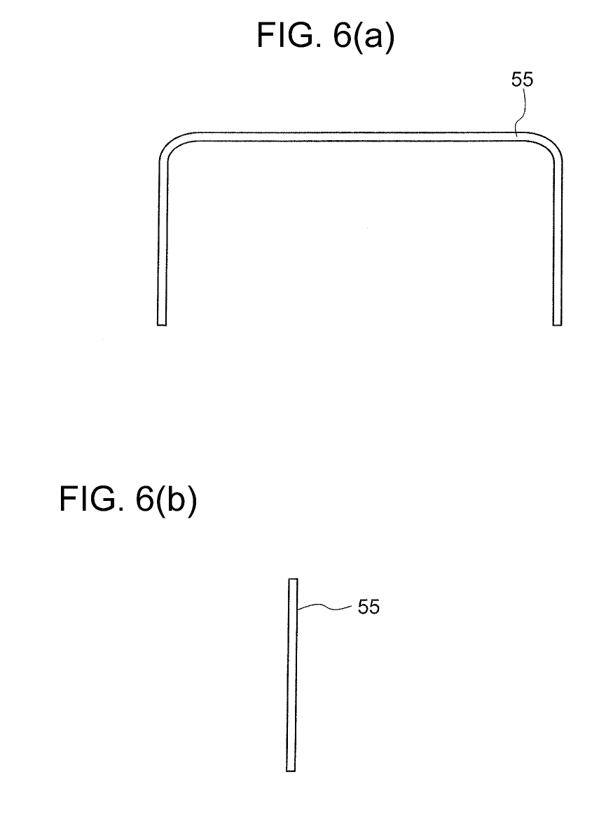

FIGS. 6(a) and 6(b) are views illustrating the seal section 55 of the seal cover 50. FIG. 6(a) is a front view and FIG. 6(b) is a side view. The seal section 55 is mounted along the boundary between the upper wall 51a and the side wall 51b in a surface of the cover main body 51 facing the end wall 51c. This seal section 55 is made of a softer material (exactly speaking, material having smaller Young's modulus) than the cover main body 51, for example, rubber, resin or the like. The resin used here includes various kinds of elastomer (e.g., polyester resin, nylon resin, polyolefin resin, acrylic resin, fluorocarbon resin or the like) or various kinds of synthetic resin (e.g., polyester resin, nylon resin, polyolefin resin, acrylic resin, fluorocarbon resin or the like). In view of chemical resistance and spring property, polyester elastomer is most preferable. The seal section 55 is in close contact with the end surface (endplate-side end surface) of the moving block main body 21 in the moving direction. When the bolts 33 as fastening members are used to fasten the cover main body 51 to the moving block main body 32, the seal section 55 is compressed between the endplate-side end surface of the moving block main body 21 and the moving block main body-side end surface of the cover main body 51. As the seal section 55 is provided, the gap between the cover main body 51 and the moving block main body 21 is completely stopped thereby to be able to prevent any foreign material from getting into the inside through this gap. The seal section 55 may be formed integral with the cover main body 51 after being formed of different materials from the cover main body 51, or may be separated from the cover main body 51.

Here, in the above-described linear guide, the intermediate plate 27, the lubricating device 23, the end seal 24, the laminated-type contact scraper 25 and the metal scraper 26 are accommodated in the moving block 20 as auxiliary devices. However, these are not necessarily mounted and may be selected according to need. The length of the cover main body 51 in the moving direction is adjusted appropriately in accordance with the mounted auxiliary devices.

As illustrated in FIG. 1, in the above-described linear guide, the seal cover 50 is provided to cover the upper surfaces and side surfaces of each endplate 22 and auxiliary devices attached to the outer end surface of the endplate 22 in the moving direction and to fully block the gap between the moving block main body 21 and the end plate 22. As such, it is possible to reliably prevent the coolant or foreign material such as swarf or dust particles from the upper side of the moving block 20 from getting into the moving block 20. Further, as the end seal 24, the laminated-type contact scraper 25 and the metal scraper 26 are mounted on each outer end surface of the endplate 22 in the moving direction as devices for preventing entry of any foreign material, it is possible to reliably prevent entry of any foreign material into the axis of the raceway rail 11 or entry of any foreign material such as swarf or dust particles stuck to or accumulated on the raceway rail 11 into the moving block 20.

In addition, the moving block main body 21, the endplates 22 and the auxiliary devices such as intermediate plates 27, lubricating devices 23, end seals 24, laminated-type contact scrapers 25, metal scrapers 26 and the like are typically fixed with bolts. In this case, they are in close contact at the part where the bolts are tightened, while there maybe a small gap between them at the other area. Even in such a case, as the seal cover 50 of the present invention is mounted, it is possible to prevent moisture, such as coolant, or any fine foreign material, such as swarf, from getting into the moving block even in the environment where the foreign material and moisture are scattered.

Further, the resin, rubber members such as the endplate 22, end seals 24 and the like may be deformed or deteriorated by any high-temperature foreign material. Even in such a case, the seal cover 50 of the present invention makes it possible to reliably prevent entry of the foreign material into the moving block and to prevent deformation and deterioration of the resin/rubber members.

Further, in supplying a lubricant such as grease or lubricating oil, there is partially created a gap due to its pressure, and the lubricant may leak onto the upper part of the endplate 22. Even in such a case, the seal cover 50 of the present invention is provided to push the upper part of the endplate 22, the intermediate plate 27 and the lubricating device 23, thereby to be able to reduce leakage of the lubricant and to facilitate flow of the lubricant to the ball rolling groove 11 that needs lubrication.

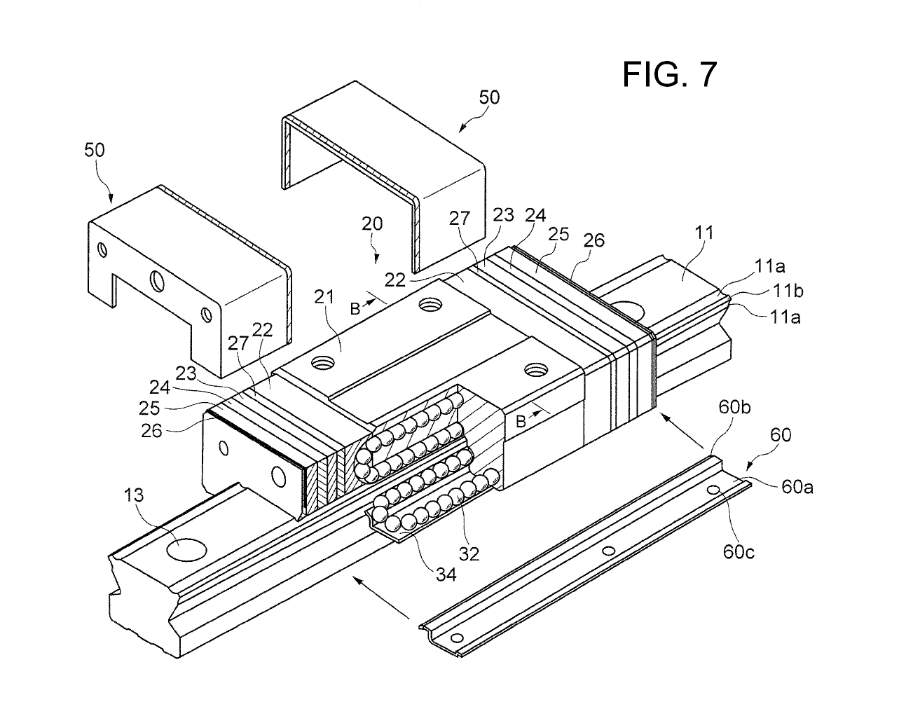

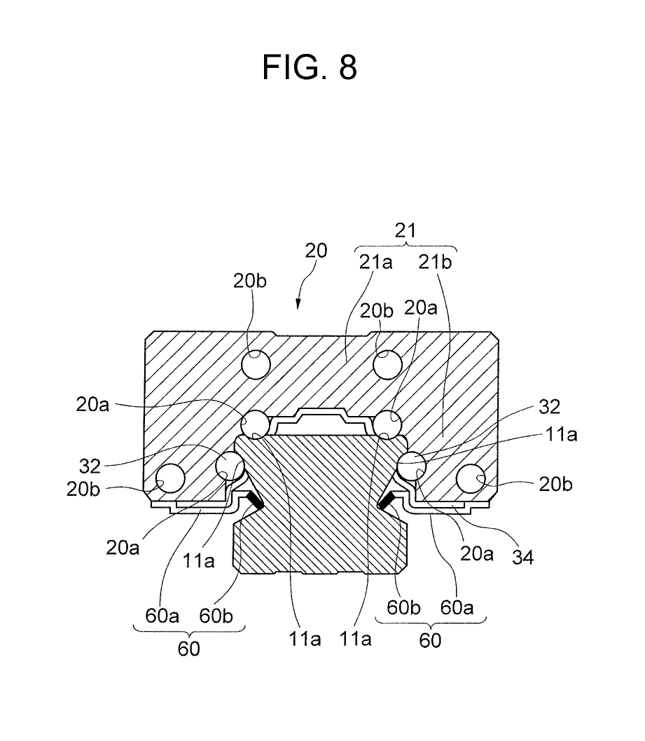

Next description is made, with reference to FIGS. 7 and 8, about another example of the above-described linear guide according to the first embodiment. FIG. 7 is an exploded perspective view illustrating another example of the linear guide and FIG. 8 is a cross sectional view taken along the arrow B in FIG. 7. Also in this example, the seal cover 50 as a feature of the present invention is mounted like in the above-described linear guide. The linear guide of this example differs from the above-described linear guide in that a side seal 60 is attached. FIG. 7 illustrates the side seal 60 which is not yet mounted and the mounting direction is shown by the arrow.

The side seal 60 is formed to have a thin plate-shaped base 60a and a seal section 60b provided at an end in the width direction. The base 60a of the side seal 60 extends, as illustrated in FIG. 7, from a metal scraper 26 attached to an end of the moving block 20 in the moving direction to the other metal scraper 26 attached to the opposite end thereof. The length of the base 60a is approximately equal to the entire length of the moving block 20 and its width is approximately equal to the width of the bottom surface of the arm 21b of the moving block 21, as illustrated in FIG. 8. Further, as illustrated in FIG. 7, the base 60a of the side seal 60 has a recess at the center in the width direction so that the holding plate 34 of the balls 32 is fit in the recess when the side seal 60 is mounted. The seal section 60b of the side seal 60 is formed at an end of the base 60a in the width direction in such a manner as to come into contact with the side surface of the raceway rail 11 when the side seal 60 is mounted on the end surface of the moving block 20. The side seal 60 covers the bottom surfaces of the arm parts 21b of the moving block main body 21 and the bottom surfaces of the endplate 22 and auxiliary devices 23 to 27 over the length of the moving block 20 so as to stop a gap between the moving block 20 and the side surface of the raceway rail 11. With this side seal 60, it is possible to reliably prevent entry of any foreign material from the bottom of the linear guide. Besides, when this side seal 60 is used together with the devices for preventing entry of any foreign material, such as end seal 24, laminated-type contact scraper 25 and metal scraper 26, the moving block 20 and the raceway rail 11 of the linear guide can be almost completely sealed thereby to be able to reliably prevent entry of any foreign material from above, bottom, front, behind, left and right. In the side seal 60, bolt holes 60c are formed. After the endplate 22 and auxiliary devices 23 to 27 are attached to the moving block main body 21, fastening members such as bolts are inserted into the bolt holes 60c of the side seal 60 from the bottom thereby to mount the side seal 60 to the bottom surface of the moving block 20.

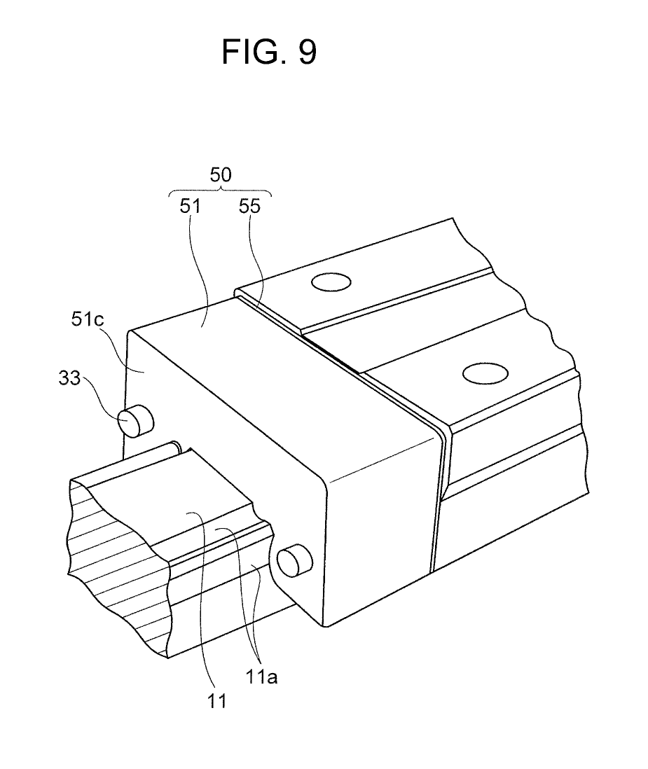

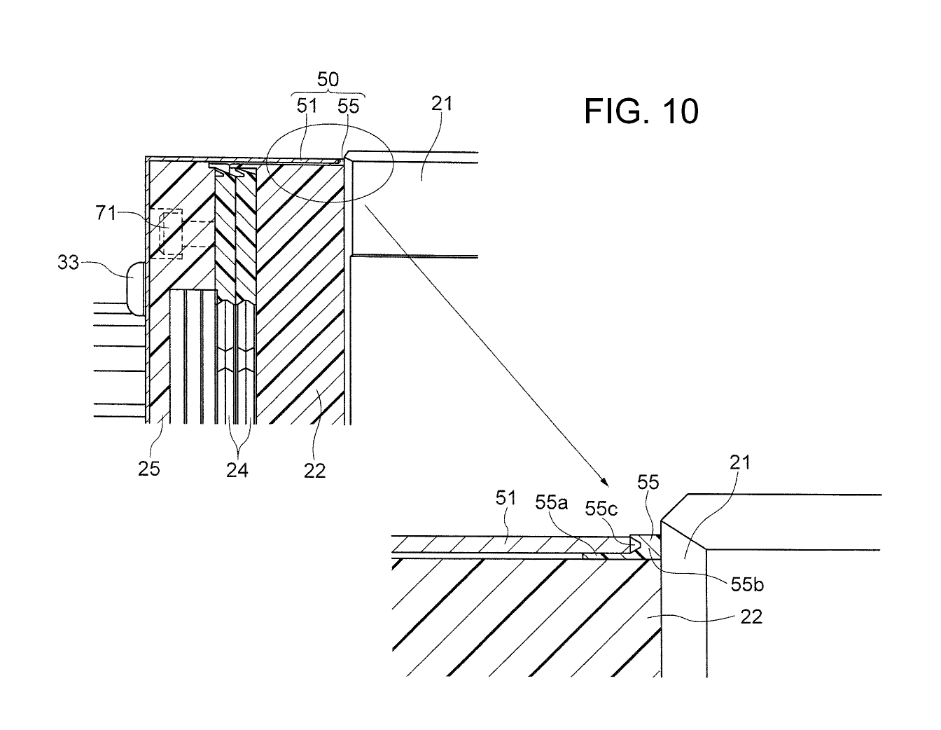

Next description is made, with reference to FIGS. 9 to 13, about yet another example of the above-described linear guide according to the first embodiment. FIG. 9 is a perspective view of yet another example of the linear guide, and FIG. 10 is a cross-sectional view of the linear guide taken along the longitudinal direction. In this example, the linear guide is the same as the above-described linear guide in that the seal cover 50 as a feature of the present invention is provided. They are different in that the seal section 55 is separate from the cover main body 51 and the end wall 51c of the cover main body 51 is also used as a metal scraper for removing the foreign material stuck to the raceway rail 11.

As illustrated in FIG. 10, on each end surface of the moving block main body 21 in the moving direction, the endplate 22 is attached, and the end seal 24 and the laminated-type contact scraper 25 are attached to the endplate 22. These endplate 22, end seal 24 and laminated-type contact scraper 25 are fixed to the moving block main body 21 with bolts 71 as fastening members.

The seal cover 50 has a cover main body 51 for covering the endplate 22 and the auxiliary devices and a seal section 55 provided between the cover main body 51 and the moving block main body 21. When the cover main body 51 is removed from the moving block, the cover main body 51 is separate from the seal section 55.

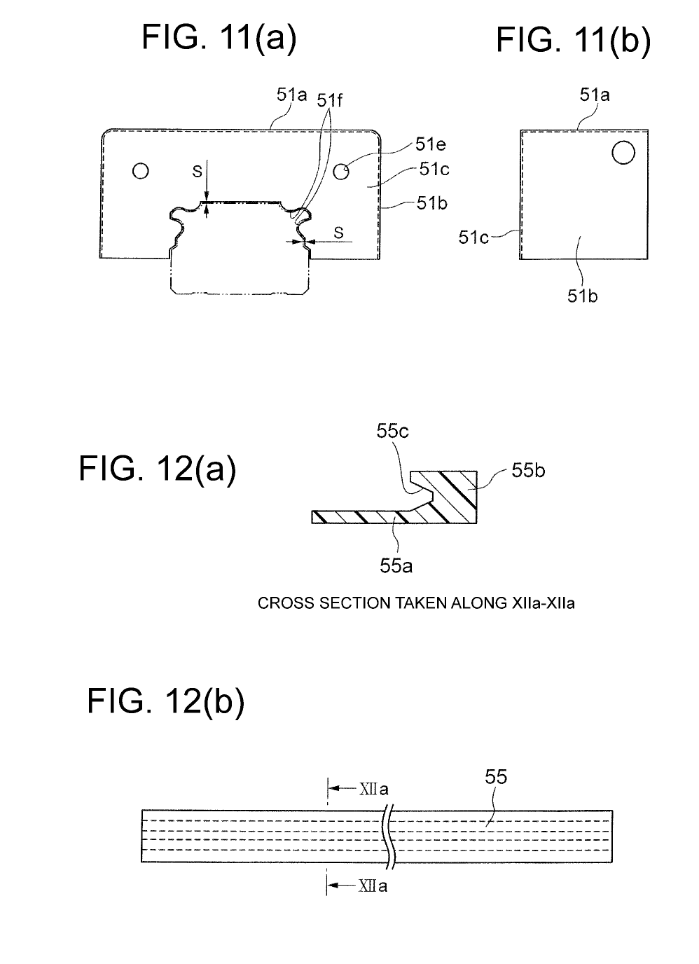

FIG. 11 illustrates the cover main body 51. The cover main body 51 has an upper wall 51a covering the upper surface of the horizontal part 22a of the endplate 22 and the auxiliary devices, a pair of side walls 51b covering right and left arm parts 22b of the endplate 22 and the auxiliary devices and an end wall 51c covering an outer end surface of the outermost auxiliary device in the moving direction. In order to serve as a scraper to remove stuck to the raceway rail 11, the end wall of the cover main body 51 has an inner shape conforming to the cross sectional shape of the raceway rail perpendicular to the longitudinal direction, and has projections 51f projecting toward the ball rolling grooves of the raceway rail 11. Between the raceway rail 11 and the end wall 51c, there is a predetermined small space S created so that the end wall 51c is out of contact with the raceway rail 11. In the end wall 51c of the cover main body 51, through holes 51e are formed for inserting the bolts 33 as fastening members.

FIGS. 12(a) and 12(b) illustrate the seal section 55. The seal section 55 is manufactured by resin molding into a flexible elongating band shape. As illustrated in FIG. 12(a), the seal section 55 has an approximately L-shaped cross section, having a thin plate-shaped thin part 55a and an approximately box-shaped seal main body 55b. As illustrated in FIG. 10, the thin part 55a is sandwiched between the cover main body 51 and the endplate 22, and the seal main body 55b is sandwiched between the end surface of the moving block main body 21 and the cover main body 51. At an end surface of the seal main body 55b on the cover main body 51 side, a notch 55c is formed so that the seal main body 55b can be easily elastically deformed when it is sandwiched between the end surface of the moving block main body 21 and the cover main body 51.

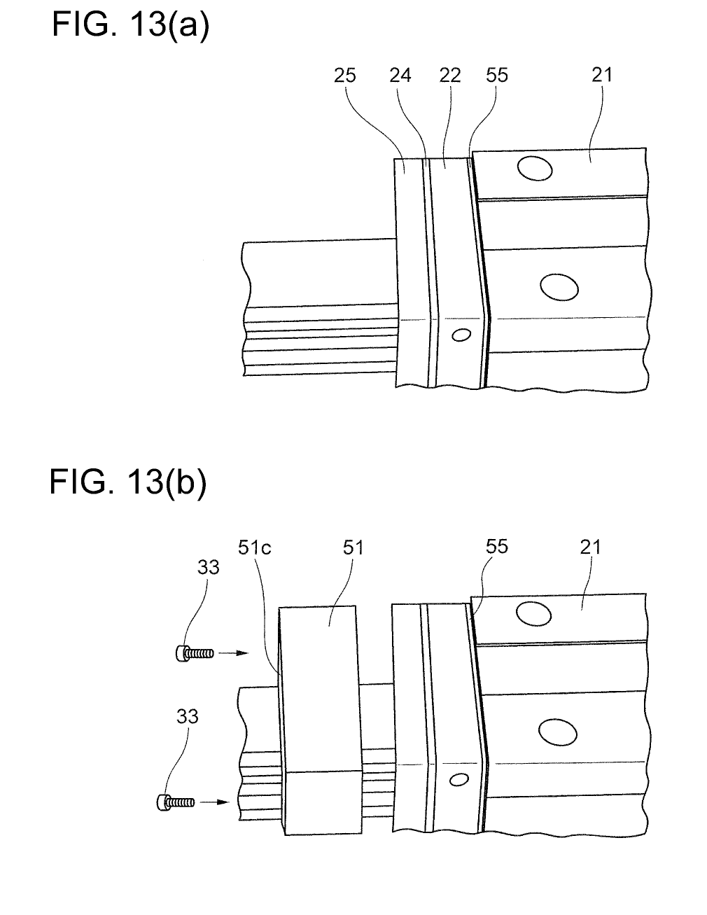

FIGS. 13(a) and 13(b) are process charts of the method for mounting the seal section 55 and the cover main body 51. First, as illustrate in FIG. 13(a), the band-shaped seal section 55 is placed in a crawling manner over the upper surface and side surfaces of the endplate 22. A small step difference is formed between the endplate 22 and the moving block main body 21, and the seal section 55 follows this step difference. The seal section 55 is not adhered to the endplate 22.

Next, as illustrated in FIG. 13(b), the cover main body 51 is fit to cover the thin part 55a of the seal section 55 around (see FIG. 10). The bolts 33 are inserted into the through holes 51e of the end wall 51c of the cover main body 51 and tightened to the moving block main body 21. Then, the cover main body 51 is pushed toward the end surface of the moving block main body 21 so that the seal main body 55b of the seal section 55 is compressed between the end surface of the moving block main body 21 and the cover main body 51. With this process, the seal section 55 and the cover main body 51 are mounted completely.

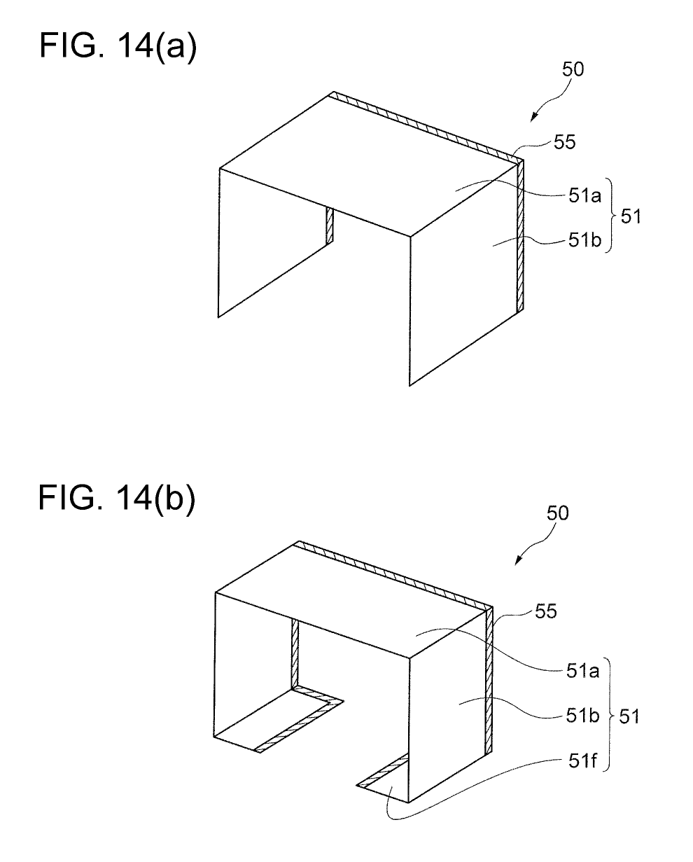

With reference to FIGS. 14(a) and 14(b), modified examples of the seal cover 50 will be described. FIG. 14 is a perspective view illustrating a first modified example of the seal cover 50. The seal cover 50 illustrated in FIG. 14(a) has a cover main body 51, which has an upper wall 51a and side walls 51b, and a seal section 55. This seal cover is different from the above-described seal cover 50 in that the end wall 51c is eliminated from the cover main body 51 and the seal cover has a U-shaped cross section. This seal cover 50 also covers the endplate 22 and auxiliary devices entirely, and the seal section 55 formed integrally at an end of the seal cover 50 is used to fill the gap between the cover main body 51 and the moving block main body 21, which makes it possible to reliably prevent any fine foreign material, such as swarf, or moisture, such as coolant, from getting into the moving block 20. In this seal cover 50 according to the first modified example, a bolt hole (not shown) is provided in the side wall 51b for fastening the seal cover to the endplate 22 or auxiliary devices.

FIG. 14(b) is a perspective view illustrating a second modified example of the seal cover 50. The seal cover 50 illustrated in FIG. 14(b) is configured by adding bottom surfaces 51f to the seal cover 50 illustrated in FIG. 14(a). Each bottom surface 51f extends from the lower end of each side wall 51b and is formed integral with the side wall 51b. Besides, the seal section 55 is extended from the upper wall 51a, via the side wall 51b to the inside end part of the bottom surface 51f so as to be in contact with the side surface of the raceway rail 11. Also in this seal cover 50, the cover main body 51 covers the endplate 22 and auxiliary devices entirely, and the seal section 55 formed integrally at an end of the seal cover 50 is used to fill the gap between the cover main body 51 and the moving block main body 21 and the gap between the side surface of the raceway rail 11 and the endplate 22, auxiliary devices 23 to 27, which makes it possible to reliably prevent any fine foreign material or moisture from getting into the moving block 20 from above and below.

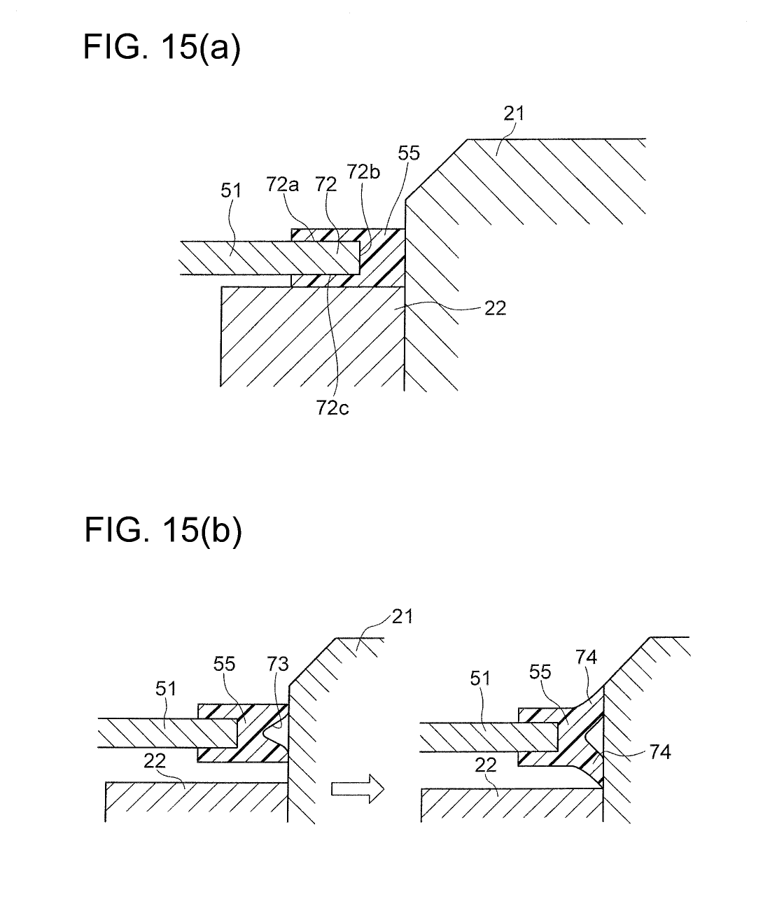

Next description is made, with reference to FIGS. 15(a) to 17(b), about modified examples of the seal section 55 and the cover main body 51. The seal section 55 illustrated in FIG. 15(a) has a U shape surrounding the upper surface 72a, the end surface 72b and the lower surface 72c of the end part 72 of the cover main body 51. As the seal section 55 is U shapes, it is possible to enhance adhesion of the seal section 55 to the cover main body 51. At the side of the seal section 55 illustrated in FIG. 15(b) in contact with the moving block main body 21, a notch 73 is formed. When the seal section 55 is compressed between the end surface of the mobbing block main body 21 and the cover main body 51, a deformation part 74 bifurcated of the seal section 55 is deformed elastically in a crashed manner, thereby enhancing the adhesion of the seal section 55 to the end surface of the moving block main body 21.

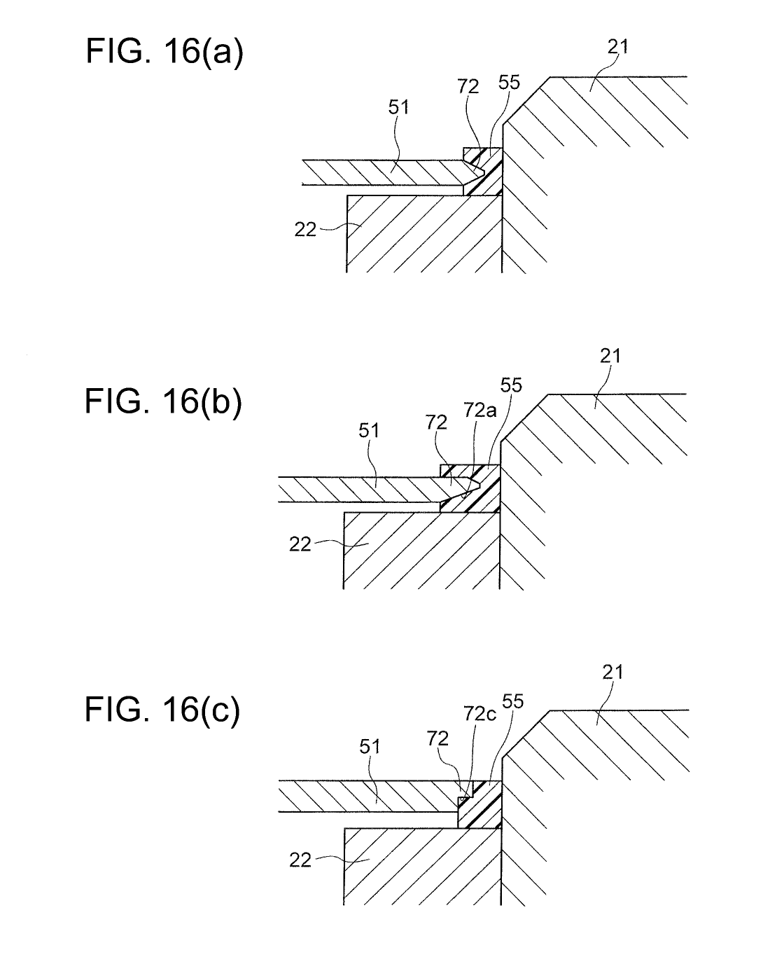

FIGS. 16(a) to 16(c) illustrate examples of the cover main body 51 of which an end surface is irregularly shaped, except a flat surface, in order to enhance the adhesion of the seal section 55 to the cover main body 51. FIG. 16(a) illustrates an example of the end part 72 of the cover main body 51 that is formed as a triangle pointed toward the seal section 55. FIG. 16(b) illustrates an example of the end part 72 of the cover main body 51 that has an inclined surface 72a pointed toward the seal section 55. FIG. 16(c) illustrates an example of the end part 72 of the cover main body 51 that has a step difference 72c formed therein.

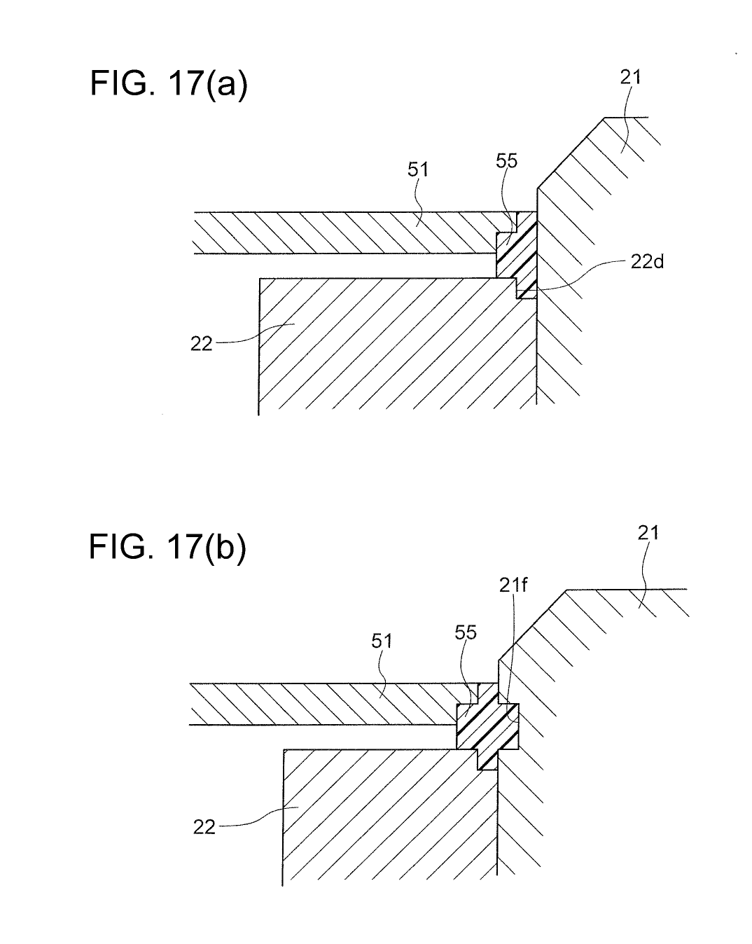

FIG. 17(a) illustrates an example of the endplate 22 in which a step difference 22d is formed to fit the seal section 55 therein. The step difference 22d is formed in the endplate 22 at the moving block main body 21 side and the projection of the seal section 55 is fit in the step difference 22d. When the endplate 22 is fixed to the moving block main body 21 by fastening members such as bolts 33, the seal section 55 is compressed between the moving block main body 21 and the endplate 22. With this compression, adhesion between the endplate 22 and the moving block main body 21 can be enhanced. Besides, the seal section 55 can be also fixed firmly. FIG. 17(b) illustrates an example of the moving block main body 21 that has a recess 21f for fitting the projection of the seal section 55 therein. As the recess 21f is formed in the moving block main body 21, the path of entry of liquid like coolant is elongated thereby to prevent entry of the liquid more reliably.

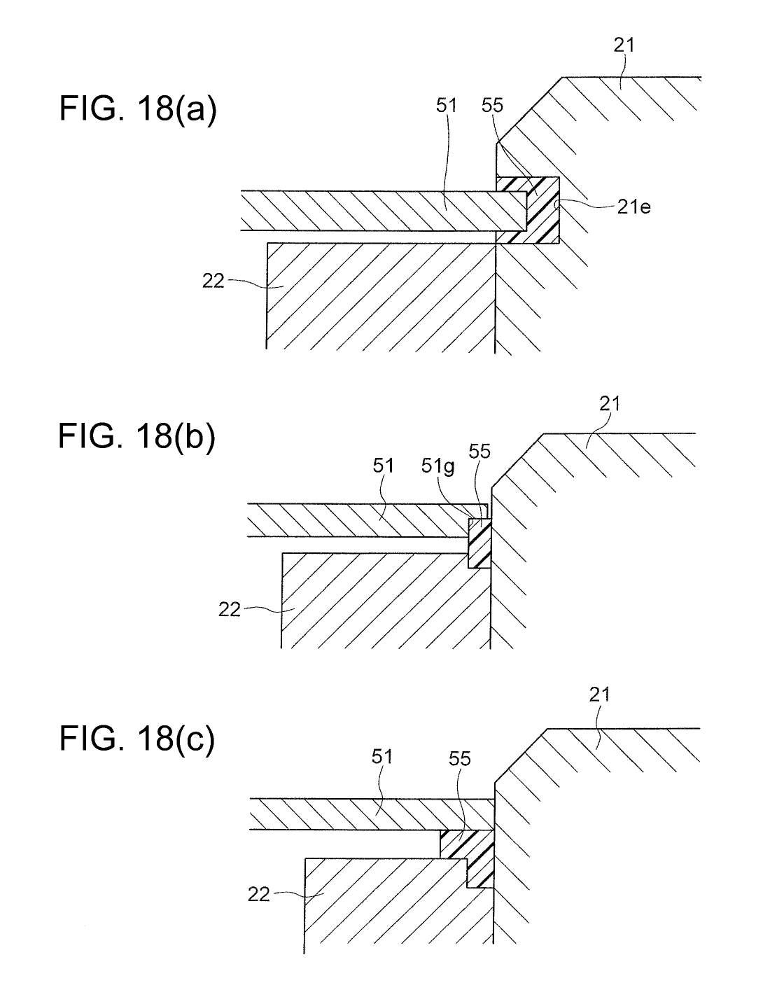

FIGS. 18(a) to 18(c) illustrate an example of the seal section 55 given with measures against coolant. The seal section 55 is made of a material having excellent chemical resistance, however, long-time exposure of the seal section 55 to coolant causes short service life of the seal section 55. In order to prevent this, measures are taken to reduce the exposed area of the seal section 55. FIG. 18(a) illustrates an example of the seal section 55 which is embedded in a recess 21e formed in the moving block main body 21 in order to reduce an exposed area of the seal section 55. As the seal section 55 is embedded in the recess 21e, the area in contact with coolant can be reduced thereby to reduce damages from the coolant. FIG. 18(b) illustrates an example of the seal section 55 covered with the cover main body 51. The cover main body 51 has a step difference 51g formed therein and the seal section 55 is sandwiched between the step difference 51g of the cover main body 51 and the end surface of the moving block main body 21. As the seal section 55 is fit inside the cover main body 51, the seal section 55 is prevented from being exposed on the surface of the cover main body 51 thereby to reduce damages by coolant. FIG. 18(c) illustrates an example of the seal section 55 which is accommodated inside the cover main body 51. An end surface of the cover main body 51 is formed flat and abuts to the end surface of the moving block main body 21. The seal section 55 accommodated in the cover main body 51 sandwiched between the endplate 22 and the moving block main body 21.

Here, in the above-described linear guide according to the first embodiment, the cover main body 51 is made of metal and the seal section 55 is made of resin, however, the cover main body 51 may be made of resin like the seal section 55. Further, the cover main body 51 and seal section 55 may be formed by injection molding of same resin material. In this case, the seal cover 50 is provided with the end wall 51c for covering the outer end surface of the endplate 22 in the moving direction or the outer end surface of an outermost auxiliary device in the moving direction. In the end wall 51c of the seal cover 50, through holes 51e are formed for inserting fastening members like bolts 33. Each fastening member is inserted into a through hole 51e of the end wall 51c and tightened up to the moving block main body 21. Then, the seal cover 51 is pushed to the end surface of the moving block main body 21 to come into intimate contact with the end surface of the moving block main body 21.

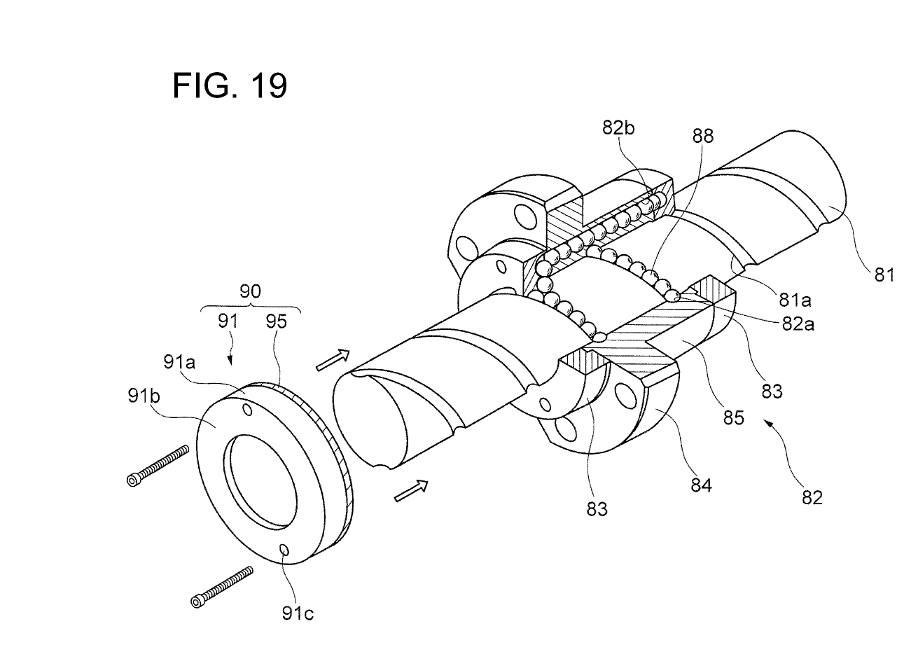

Next description is made about a screw device according to a second embodiment of the present invention, with reference to a perspective view of FIG. 19. The screw device according to this embodiment has a screw shaft 81 with a spiral ball rolling groove 81a formed on an outer peripheral surface thereof and a nut 81 with a spiral loaded ball rolling groove 82a formed on an inner peripheral surface thereof, facing the ball rolling groove 81a.

The screw shaft 81 is formed of a steel bar of carbon steel, chrome steel, stainless steel or the like, and on the outer peripheral surface thereof, the spiral ball rolling groove 81a with a predetermined lead is formed by cutting, grinding or rolling. The number of threads of the ball rolling groove 81a may be set to one, two, three or any number. The cross section of the ball rolling groove 81a is a circular arc groove shape formed of a single arc or a Gothic arch groove shape formed of combined two arcs.

The nut 82 is formed of a steel bar of carbon steel, chrome steel, stainless steel or the like, and in an inner peripheral surface of the nut 82, the spiral loaded ball rolling groove 82a with a predetermined lead is formed by cutting, grinding or rolling. The nut 82 has a nut main body 85 with the loaded ball rolling groove 82a formed on the inner peripheral surface thereof and a pair of end caps 83 as cap members provided at both ends of the nut main body 85. At an end of the outer periphery of the nut main body 85, a flange 84 is formed for mounting the nut 82 onto another device. The loaded ball rolling groove 82a of the nut main body 85 faces the ball rolling groove 81a of the screw shaft 81. In the nut main body 85, a ball return path 82b is formed to pass through the nut main body 85 in the axial direction for circulation of the balls 88. In each end cap 83, a direction change path is formed for scooping up each ball 88 rolling in the ball rolling groove 81a of the screw shaft 81 and leading it to the ball return path 82b. The ball rolling groove 81a of the screw shaft 81 and the loaded ball rolling groove 82a of the nut main body 85 form a loaded ball rolling path. The loaded ball rolling path, the direction change paths and the ball return path 82b form a ball circulation path, in which a plurality of balls 88 is arranged and accommodated. In order to prevent contact between balls 88, a retainer may be provided between the balls 88 according to need.

When the screw shaft 85 is rotated, the nut 82 fit around the screw shaft 81 via the balls 88 moves in the axial direction. At the same time, the balls 88 circulate in the ball circulation path. Once the balls 88 rolling in the loaded ball rolling path reach an end of the loaded ball rolling path, they are scooped into the direction change path of the end cap 83, roll in the ball return path 82b and are returned to the opposite end of the loaded ball rolling path by the opposite-side end cap 83.

The reference numeral 90 denotes a seal cover that is a feature of the present invention. In FIG. 19, the seal cover 90 is provided only at one side, however, may be provided at each of end caps 83 provided at both ends of the nut main body 85. The seal cover 90 has a cover main body 91 and a seal section 95. The cover main body 91 has a cylindrical side surface 91a and an end surface 91b formed integral with an end of the side surface 91a. In the end surface 91b, a hole is formed at the center thereof for insertion of the screw shaft 81. The seal cover 90 is mounted so as to cover the end cap from the outside in the axial direction after the end cap 83 is mounted on the nut main body 85. The seal section 95 of the seal cover 90 is in intimate contact with the end cap-side end surface of the nut main body 85 to fill a gap between the cover main body 91 and the nut main body 85. As this seal cover 90 is provided, it is possible to protect the end cap from any high-temperature foreign material and to prevent any foreign material from getting into the nut 82 via a gap between the end cap 83 and the nut main body 85. The seal cover 90 can be fixed to the end cap 83 by inserting a fastening member such as a bolt into a bolt hole 91c provided in the end surface 91b after covering the seal cover 90 over the end cap 83.

The present invention is not limited to the above-described embodiments and may be embodied in various forms without departing from the scope of the present invention. For example, the present embodiments have been described by way of example where the balls 32 are used as rolling elements. However, the rolling elements are not limited to the balls but may be rollers. Further, the cover main body and the seal section may be separated from each other and the seal section may be sandwiched between the cover main body and the moving member main body.

Further, in the above-described embodiments, the present invention is applied to the linear guide and screw device. However, these are not intended for limiting the present invention, and the present invention is also applicable to a spline device that has an end cap at each end of the spline nut.

The present specification is based on Japanese Patent Applications No. 2009-130825 filed on May 29, 2009 and No. 2010-099877 filed on Apr. 23, 2010, the entire contents of which are expressly incorporated by reference herein.

### REFERENCE NUMERALS

11 . . . raceway rail (raceway member), 11a . . . ball rolling groove (rolling-element rolling part), 20 . . . moving block (moving member), 20a . . . loaded ball rolling groove (loaded rolling-element rolling part), 20b . . . ball return path (rolling-element return path), 21 . . . moving block main body (moving member main body) , 22 . . . endplate (cap member), 32 . . . ball, 27 . . . intermediate plate (auxiliary device), 23 . . . lubricating device (auxiliary device), 25 . . . laminated-type contact scraper (auxiliary device), 26 . . . metal scraper (auxiliary device), 50 . . . seal cover, 51 . . . cover main body, 51a . . . upper surface, 51b . . . side surface, 51c . . . end surface, 55 . . . seal section, 60 . . . side seal, 61b . . . seal section, 81 . . . screw shaft, 81a . . . ball rolling groove (rolling-element rolling part), 82a . . . loaded ball rolling groove (loaded rolling-element rolling part), 82b . . . ball return path (rolling-element return path), 85 . . . nut main body, 83 . . . end cap (cap member), 90 . . . seal cover, 91 . . . cover main body, 95 . . . seal section

1. A motion guide device comprising:
a raceway member having a rolling-element rolling part that extends in a longitudinal direction;
a moving member having a moving member main body and cap members, the moving member main body having a loaded rolling-element rolling part facing the rolling-element rolling part of the raceway member and a rolling-element return path extending approximately in parallel to the loaded rolling-element rolling part, and the cap members being provided at respective ends of the moving member main body in a relative moving direction and having direction change paths formed therein that connect the loaded rolling-element rolling part of the moving member main body and the rolling-element return path;
a plurality of rolling elements being arranged in a rolling-element circulation path that includes a loaded rolling-element rolling path between the rolling-element rolling part of the raceway member and the loaded rolling-element rolling part of the moving member main body, the rolling-element return path and the direction change paths; and
a seal cover having a cover main body that covers each of the cap members and a seal section that is provided between the cover main body and a cap member-side end surface of the moving member main body to stop a gap between the cap member-side end surface of the moving member main body and the cover main body.

2. The motion guide device of claim 1, wherein the moving member has at least one of auxiliary devices including a lubricating device and devices for preventing entry of any foreign material, and the cover main body is configured to cover the at least one auxiliary device attached to the cap member.

3. The motion guide device of claim 1, wherein the cover main body is fastened to the moving member by a fastening member and the seal section is compressed between the cover main body and the cap member-side end surface of the moving member main body.

4. The motion guide device of claim 1, wherein
the cover main body has an end wall that covers an outer end surface of the cap member in the relative moving direction,
a through hole is formed in the end wall of the cover main body for inserting a fastening member thereinto, and
the fastening member is inserted into the through hole of the end wall and tightened up to the moving member so that the cover main body is pushed toward the cap member-side end surface of the moving member main body and the seal section is compressed between the cover main body and the cap member-side end surface of the moving member main body.

5. The motion guide device of claim 2, wherein
the cover main body has an end wall that covers an outer end surface of the auxiliary device in the relative moving direction,
a through hole is formed in the end wall of the cover main body for inserting a fastening member thereinto, and
the fastening member is inserted into the through hole of the end wall and tightened up to the moving member so that the cover main body is pushed toward the cap member-side end surface of the moving member main body and the seal section is compressed between the cover main body and the cap member-side end surface of the moving member main body.

6. The motion guide device of claim 4, further comprising an intermediate plate that is configured to stop a gap created in the seal cover in which the cap member is accommodated.

7. The motion guide device of claim 5, further comprising an intermediate plate that is configured to stop a gap created in the seal cover in which the cap member and the auxiliary device are accommodated.

8. The motion guide device of claim 1, wherein
when the raceway member is arranged on a horizontal plane, the moving member main body has a horizontal part facing an upper surface of the raceway member and a pair of arm parts facing left and right side surfaces of the raceway member in a width direction, and
the motion guide device further comprises a side seal that is configured to stop a gap created between the left and right side surfaces of the raceway member and the arm parts in pair of the moving member main body.

9. The motion guide device of claim 4 or 5, wherein
the end wall of the cover main body has an inner shape which conforms to a cross sectional shape of the raceway rail perpendicular to the longitudinal direction and has a projection projecting toward the rolling-element rolling part of the raceway member, and
the end wall is out of contact with the raceway member and acts as a scraper for removing any foreign material stuck to the raceway member.

10. A seal cover mounted on a motion guide device having a raceway member having a rolling-element rolling part that extends in a longitudinal direction, a moving member having a moving member main body and cap members, the moving member main body having a loaded rolling-element rolling part facing the rolling-element rolling part of the raceway member and a rolling-element return path extending approximately in parallel to the loaded rolling-element rolling part, and the cap members being provided at respective ends of the moving member main body in a relative moving direction and having direction change paths formed therein that connect the loaded rolling-element rolling part of the moving member main body and the rolling-element return path, and a plurality of rolling elements being arranged in a rolling-element circulation path that includes a loaded rolling-element rolling path between the rolling-element rolling part of the raceway member and the loaded rolling-element rolling part of the moving member main body, the rolling-element return path and the direction change paths, the seal cover comprising:
a cover main body that covers each of the cap members; and
a seal section that is provided between the cover main body and a cap member-side end surface of the moving member main body to stop a gap between the cap member-side end surface of the moving member main body and the cover main body.

11. A motion guide device comprising:
a raceway member having a rolling-element rolling part that extends in a longitudinal direction;
a moving member having a moving member main body and cap members, the moving member main body having a loaded rolling-element rolling part facing the rolling-element rolling part of the raceway member and a rolling-element return path extending approximately in parallel to the loaded rolling-element rolling part, and the cap members being provided at respective ends of the moving member main body in a relative moving direction and having direction change paths formed therein that connect the loaded rolling-element rolling part of the moving member main body and the rolling-element return path;
a plurality of rolling elements being arranged in a rolling-element circulation path that includes a loaded rolling-element rolling path between the rolling-element rolling part of the raceway member and the loaded rolling-element rolling part of the moving member main body, the rolling-element return path and the direction change paths; and
a cover configured to cover each of the cap members, the cover having an end wall for covering an outer end surface of the cap member in the relative moving direction or an outer end surface of at least one auxiliary device including a lubricating device and a device for preventing entry of any foreign material, the end wall of the cover having a through hole formed therein for inserting a fastening member, the fastening member being inserted into the through hole of the end wall and tightened to the moving member so that the cover is pushed to a cap member-side end surface of the moving member main body to come into intimate contact with the cap member-side end surface of the moving member main body.

12. A screw device comprising:
a screw shaft having a spiral rolling-element rolling part formed on an outer peripheral surface;
a nut main body having a spiral loaded rolling-element rolling part that is formed on an inner peripheral surface to face the rolling-element rolling part of the screw shaft and a rolling-element return path that connects one end of the loaded rolling-element rolling part to an opposite end;
cap members that are provided at respective ends of the nut main body and have direction change paths formed therein connecting the rolling-element return path and the loaded rolling-element rolling part of the nut main body;
a plurality of rolling elements that are arranged in a loaded rolling-element rolling path between the rolling-element rolling part of the screw shaft and the loaded rolling-element rolling part of the nut main body, the rolling-element return path and the direction change paths; and
a seal cover having a cover main body that covers each of the cap members and a seal section that is provided between the cover main body and a cap member-side end surface of the nut main body to stop a gap between the cap member-side end surface of the nut main body and the cover main body.
